(19) United States
(12) Patent Application Publication
(10) Pub. No.: US 2012/0215969 A1
(43) Pub. Date: Aug. 23, 2012

(54) STORAGE DEVICE AND CONTROL METHOD THEREOF

(75) Inventors: Masaaki Tamura, Yokohama-shi (JP); Masakazu Tsuruoka, Akiruno-shi (JP)

(73) Assignee: KABUSHIKI KAISHA TOSHIBA, Tokyo (JP)

(21) Appl. No.: 13/402,634

(22) Filed: Feb. 22, 2012

(30) Foreign Application Priority Data
Feb. 23, 2011 (JP) 2011-037605

(51) Int. Cl. G06F 12/02; G06F 12/08

(52) U.S. Cl. 711/103; 711/129; 711/E12.008; 711/E12.046

(57) ABSTRACT

According to one embodiment, a storage device includes: a backup unit configured to perform backup at the time of a power shutoff; a storage module configured to store information; a cache memory configured to perform caching of the storage module; and a controller configured to adjust a size of a cache to the cache memory according to exhaustion of the backup unit.

### CROSS REFERENCE TO RELATED APPLICATION(S)

The application is based upon and claims the benefit of priority from Japanese Patent Application No. 2011-037605 filed on Feb. 23, 2011, the entire contents of which are incorporated herein by reference.

### BACKGROUND

1. Field

An embodiment of the present invention relates to a storage device having a backup power source, and a control method thereof.

2. Description of the Related Art

Contrivances have been made to change the operation of a device according to the condition of the power source. For example, there is a contrivance in which, in summary, the write operation mode is changed to a write-back mode or to a write-through mode according to the voltage value of battery.

Moreover, it is performed to use, as the backup power source, a capacitor (e.g. an electric double layer capacitor) or the like that is simpler than a battery.

On the other hand, a problem of the exhaustion of the backup power source arises particularly with the backup power source by the electric double layer capacitor or the like that is simpler than the battery, and there is a demand for changing the operation of the device according to the exhaustion. However, no means for realizing such the demand is known.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing the structure of the present embodiment;

FIG. 2 is a graph of aged deterioration of an electric double layer capacitor of the embodiment;

FIG. 3 is a flowchart showing an outline of a control method of a device having a backup power source of the embodiment;

FIG. 4 is a view showing an effect of the embodiment produced when the amount of write-cacheable data is adjusted; and

FIG. 5 is a flowchart showing an outline of a control method of the capacity measurement of FIG. 3 by the device having a backup power source.

### DETAILED DESCRIPTION

According to one embodiment, a storage device includes: a backup unit configured to perform backup at the time of a power shutoff; a storage module configured to store information; a cache memory configured to perform caching of the storage module; and a controller configured to adjust a size of a cache to the cache memory according to exhaustion of the backup unit.

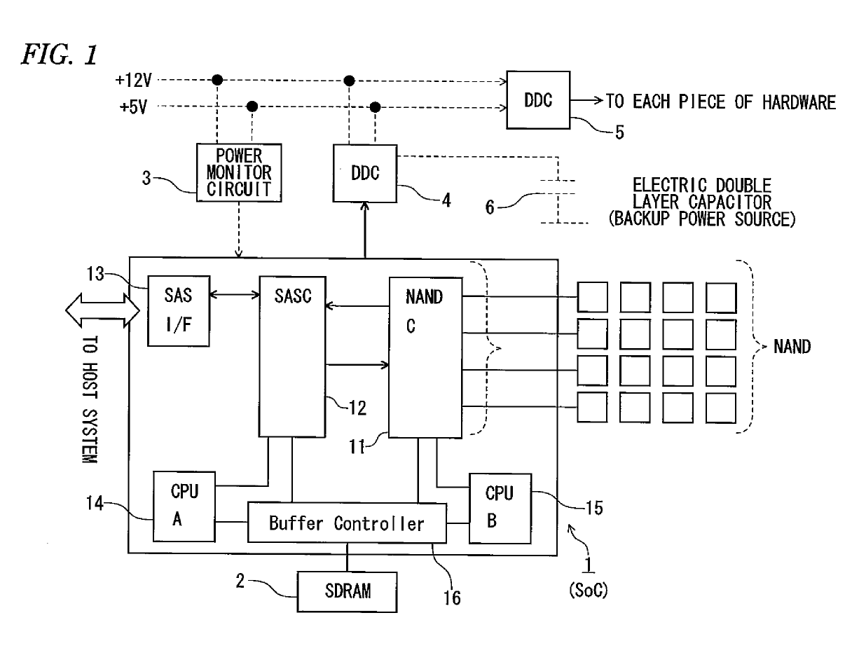

Hereinafter, the present embodiment will be described with reference to FIGS. 1 to 5.

FIG. 1 shows a schematic view of a storage device provided with a nonvolatile memory.

To an SoC (system on chip) 1 that controls a NAND nonvolatile memory, an SDRAM 2, a power monitor circuit 3, and a DDC (DC-DC converter) 4 are connected to communicate with a host system such as an external PC (personal computer). Moreover, the DDC 4, together with the power monitor circuit 3 and a DDC 5, is supplied with two kinds of voltages of +5 V and +12 V, and also, is supplied with a voltage from or supplies a voltage to an electric double layer capacitor 6.

Moreover, in the SoC 1, the following are present: a NANDC (NAND controller) 11, a SASC (SAS controller) 12, a SAS (serial attached SCSI) I/F (interface) 13, a CPU A 14, a CPU B 15, and a buffer controller 16. The NANDC 11 is connected to the external NAND nonvolatile memory, and the buffer controller 16 is connected to the SDRAM 2.

When a power shutoff is detected by the power monitor circuit 3, power is supplied from the electric double layer capacitor 6 to each piece of hardware, and the write cache data that is present on the SDRAM 2 is written into the nonvolatile memory. As for the capacity of the electric double layer capacitor 6, for example, capacitors having capacities of 100 mF to 150 mF have been developed.

From the host system, commands described later are received by way of the SAS I/F 13. At this time, the SASC 12 controls the SAS I/F 13 to communicate with the NANDC 11, the CPU A 14, and the buffer controller 16.

For example, the commands are held in the SDRAM 2 by way of the buffer controller 16, and then, are fetched by the CPU A 14 to be executed. The CPU A 14 acts on the CPU B 15 through the buffer controller 16 to operate the NANDC 11 so as to control recording to the NAND nonvolatile memory or reading from the memory.

The user data from the host system to be written into the NAND nonvolatile memory passes through the SAS I/F 13, the SASC 12, and the NANDC 11. Reading of this user data takes the opposite route.

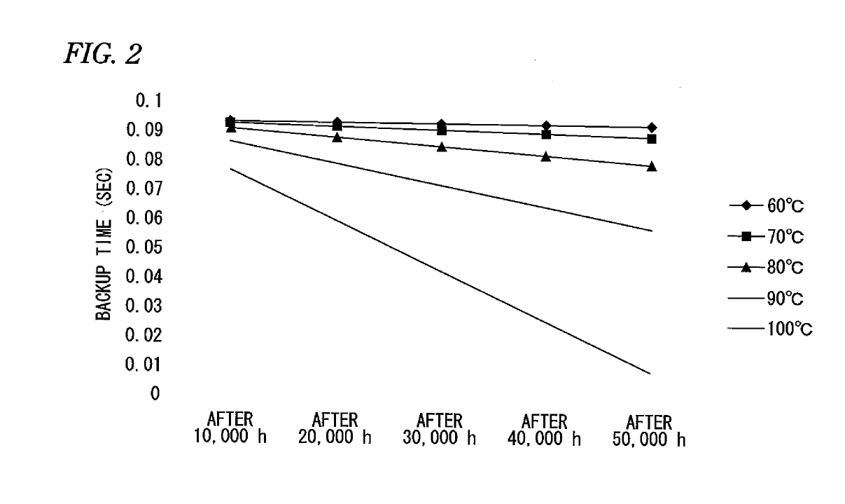

FIG. 2 shows a graph of aged deterioration of the electric double layer capacitor 6. The horizontal axis represents the elapsed time, and the vertical axis represents the backup time. This figure is expressed with five steps of temperatures as parameters. For example, at the highest temperature (100 degrees C.), the backup time is reduced to not more than 0.01 (seconds) after 50,000 hours, whereas at the lowest temperature (60 degrees C.), the backup time is held at not less than 0.09 (seconds) even after 50,000 hours, and little reduction is seen in backup time (the degree of exhaustion, hereinafter, referred to as exhaustion degree).

In general, conventionally, the amount of data to be write-cached is fixed, and the exhaustion degree at the expiration of the warranty period of the device is predicted to determine the fixed data amount. Since the exhaustion degree of the electric double layer capacitor changes according to the temperature and humidity as described above, it is necessary to consider the worst environment within the warranty period of the device, and it is necessary to set a data amount significantly smaller than the capability.

Contrarily, in the present embodiment, this data amount is variably used. This operation will be described below. Basically, this is performed by the following two data amount handling methods:

(1) The condition of the electric double layer capacitor is checked at power-on and at regular intervals (e.g. once a day), and the amount of write-cacheable data is obtained. The storage device performs write processing according to the measurement value of the exhaustion degree representative of the condition.

(2) In addition to (1), a command is prepared to perform confirmation of the data amount and specification of a data amount (a capacity or a ratio) within the range of the confirmed data amount, and the storage device performs write processing according to the specification.

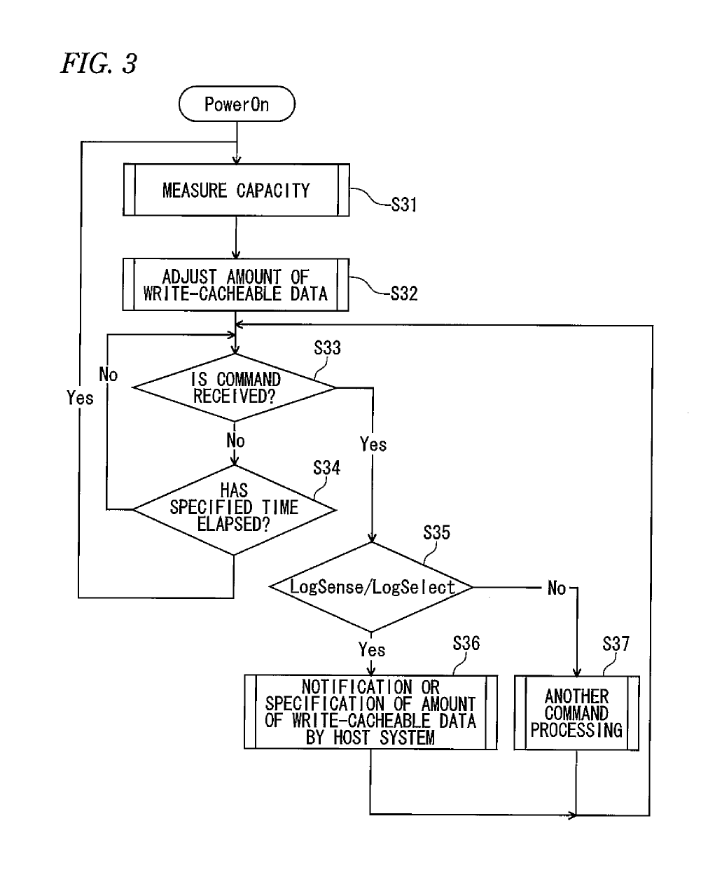

FIG. 3 shows an outline of a control method of the device having the backup power source.

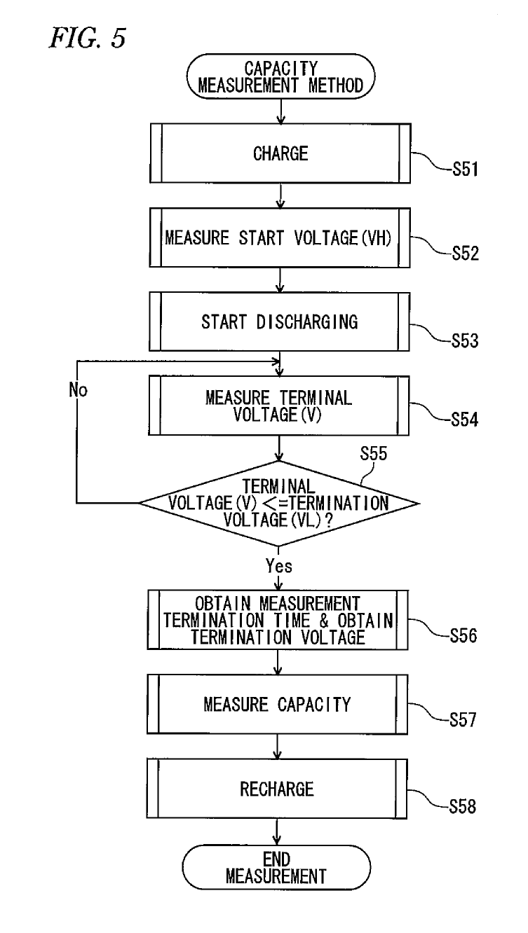

That is, capacity measurement (details will be described later with reference to FIG. 5) is performed at power-on and at regular intervals (e.g. once a day), and the storage device of the present embodiment performs adjustment of the amount of write-cacheable data. In the case of the SAS (SCSI) standard, command processing is constituted by a combination of a command, data, and a status. The management, by the host system, of the amount of write-cacheable data measured by the storage device is enabled by enabling notification and reference by using a LOG SENSE/LOG SELECT command of the SCSI standard.

The command of the SCSI standard is processed by an SSP frame sequence. The frame is transmitted between one or more connections. For example, the COMMAND frame is transmitted by a connection established by the SSP INIT port (the data and the status are transmitted as a DATA frame and a RESPONSE frame, respectively, by one or more connections established by the SSP TARG port).

The command of the input and output operation from the INIT (initiator) to the SSD (solid state drive) as a command format is provided by a CDB (command descriptor block). The CDB is information transferred from the INIT to the TARG by a command frame. For some commands, there are cases where parameters necessary for executing the commands are specified by a data frame in addition to the specification of the CDB.

The LOG SENSE command which is one of the control/sense commands among four systems of commands provides means for the INIT to collect the statistical information held by the SSD. Moreover, the LOG SELECT command provides means for the INIT to manage the statistical information maintained by the SSD with respect to the SSD. The INIT can find the kind of the statistical information and the value of the currently held statistical information by using the LOG SENSE command.

Description of FIG. 3 for each step is as follows:

Step S31: First, the capacity is measured.
Step S32: The amount of write-cacheable data is adjusted according to the result of the capacity measurement.
Step S33: Then, command reception is performed. When a command arrives, the process proceeds to step S35.
Step S34: When a specified time has elapsed before a command arrives at step S33, the process returns to step S31, and until then, the process returns to step S33.
Step S35: The contents of the command is determined, and when the command is the LOG SENSE/LOG SELECT command, notification or specification of the amount of write-cacheable data by the host system is performed, and the process returns to step S33. In the case of another command, the processing of this command (including communicator for notifying the host system of the cache size or receiving specification of the cache size from the host system) is performed, and the process returns to step S33.

While conventionally, the write-cached data amount is fixed and data loss can be caused at the time of a power shutoff, this can be prevented according to the present technology.

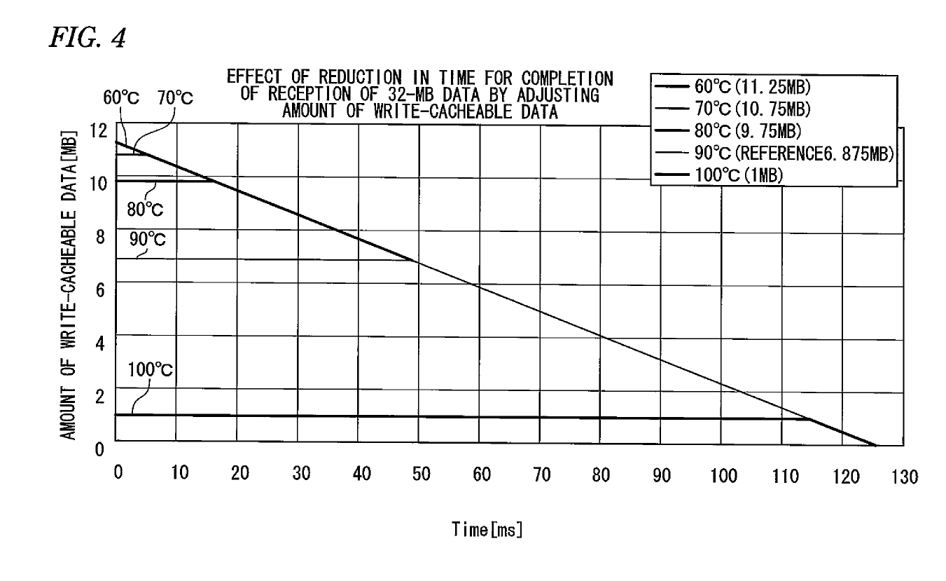

FIG. 4 shows an effect produced when the amount of write-cacheable data is adjusted. This figure is expressed with five steps of temperatures as parameters.

For example, at the highest temperature (100 degrees C.), the amount of write-cacheable data is saturated at one MB, and after 115 msec, the cached data is discharged in such a way as to be along the slanting line of the graph of FIG. 4, and the cache processing is brought to an end. Contrarily, at the lowest temperature (60 degrees C.), the amount of write-cacheable data is held at 11.25 MB (the processing is brought to an end immediately after the end of transfer to the host [=0 msec]). The slanting line connecting 11.25 MB on the vertical axis and approximately 125 msec on the horizontal axis and along which the processing is brought to an end is a line common to the parameters (at 100 degrees C., power can be shut off after 115 msec).

As described above, the amount of write-cacheable data can be set to a large amount with consideration also given to the temperature, so that the data reception capability increases, the write performance close to the limit under a condition where the backup power source is not exhausted can be exploited and a failure in writing at the time of exhaustion can be prevented.

FIG. 5 shows an outline of a control method of the capacity measurement of FIG. 3 by the device having a backup power source.

Description of this for each step is as follows:

Step S51: First, the electric double layer capacitor 6 is charged.
Step S52: Then, the discharge start voltage (VH) of the electric double layer capacitor 6 is measured.
Step S53: Then, the “set measurement termination time of the capacity measurement is obtained” and discharging is started.
Step S54: Then, the terminal voltage (V) of the electric double layer capacitor 6 is measured.
Step S55: It is determined whether or not this terminal voltage (V) is lower than or equal to the measured discharge termination voltage (VL) of the electric double layer capacitor 6. When the result of the determination is yes, the process proceeds to step S56. When the result of the determination is no, the process returns to step S54.
Step S56: Then, the measurement termination time is obtained and the termination voltage is obtained.
Step S57: Then, the capacity is measured.
Step S58: Lastly, recharging is performed The present embodiment relates to a control method of a device provided with a backup power source (electric double layer capacitor, etc.) as a guarantee of unwritten data at the time of a power shutoff in order to use the write cache function as means for performance improvement in a storage device (SSD, etc.).
Effects are as follows:

(1) The write cache data amount is determined according to the exhaustion degree of the backup power source. The write performance close to the limit under a condition where the backup power source is not exhausted can be exploited and a failure in writing at the time of exhaustion can be prevented.

(2) Means is provided for notifying the host system of the amount of write-cacheable data. Sorting can be made such as using products having high performance with respect to the amount of write-cacheable data for high access systems and using products having low performance for low access systems. In a system (e.g. RAID) constituted by a combination of a plurality of storage devices, the present embodiment may be used to determine whether to replace a device the performance of which is significantly degraded or not.

(3) Means is provided for specifying the amount of write-cacheable data from the host system.

By these, in a system constituted by a combination of a plurality of storage devices, the present embodiment may be used for means for leveling out the performance.

As described above, the amount of write-cacheable data is adjusted according to the exhaustion degree of the backupable power source. As a summary, the following have been described:

control to adjust the amount of write-cacheable data according to the exhaustion degree of the backup power source; control having means for notifying the host system of the amount of write-cacheable data; and control having means for receiving specification of the amount of write-cacheable data from the host system.

The present invention is not limited to the above-described embodiment, but maybe otherwise carried out in the form of various modifications without departing from the gist of the invention. The SATA standard and the like may be used as well as the SCSI standard.

Moreover, by appropriately combining a plurality of elements disclosed in the above-described embodiment, various inventions may be formed. For example, some elements may be deleted from all the elements shown in the embodiments. Further, elements related to different embodiments may be appropriately combined.

What is claimed is:

1. A storage device comprising:
a backup unit configured to perform backup at the time of a power shutoff;
a storage module configured to store information;
a cache memory configured to perform caching of the storage module; and
a controller configured to adjust a size of a cache to the cache memory according to exhaustion of the backup unit.

2. The storage device according to claim 1, wherein the controller reduces the cache size as the exhaustion of the backup unit is increased.

3. The storage device according to claim 1, wherein the backup unit comprises a capacitor.

4. The storage device according to claim 1, wherein the storage module is a nonvolatile semiconductor memory.

5. The storage device according to claim 1, further comprising
a communicator configured to notify an external host system of the cache size or receive specification of the cache size from the host system.

6. A control method of a storage device that comprises: a memory for storage module; and a cache memory configured to perform caching of the memory for storage module, and is configured to perform backup at the time of a power shutoff, the method comprising:
previously measuring exhaustion of a backup power source that performs backup of the storage device, and
adjusting a size of a cache to the cache memory according to the exhaustion.

7. The control method according to claim 6, wherein
the cache size is reduced as the exhaustion of the backup unit is increased.

8. The control method according to claim 6, wherein
the storage device comprises a capacitor.

9. The control method according to claim 6, wherein
the storage module is a nonvolatile semiconductor memory.

10. The control method according to claim 6, wherein
the storage device further comprising a communicator configured to notify an external host system of the cache size or receive specification of the cache size from the host system.
